(19) United States
(12) Patent Application Publication
(10) Pub. No.: US 2013/0125371 A1
(43) Pub. Date: May 23, 2013

(54) Method to Construct Masterpiece Custom Triple Pane Tabletops

(71) Applicant: Joel P. DEBUS, San Diego, CA (US)

(72) Inventor: Joel P. DEBUS, San Diego, CA (US)

(21) Appl. No.: 13/300,263

(22) Filed: Nov. 18, 2011

(51) Int. Cl. B23Q 3/00

(52) U.S. Cl. 29/464

(57) ABSTRACT

A method of constructing a triple pane unit for encapsulating a decorative center piece. The center piece being a pane of leaded glass or wrought iron is encapsulated by two panes of glass. An adhesive is applied to the perimeter of the leaded glass/wrought iron for the alignment and adhering of the two panes of glass.

The current application claims a priority to the U.S. Provisional Patent application Ser. No. 61/365,688 filed on Jul. 19, 2010 and the U.S. Provisional Patent application Ser. No. 61/379,646 filed on Sep. 02, 2010.

### FIELD OF THE INVENTION

The present invention generally relates to a custom made tabletop. More specifically, the invention provides a new method to construct tabletops that present a decorative look and feel to standard patio tables.

### BACKGROUND OF THE INVENTION

Currently, patio tabletops are constructed with a single pane of ⅛″ thick glass. The main dilemma with the current method of construction is that a single layer of glass is thin and could crack easily. Many of the current patio tables additionally have designs embedded within the glass surface. The cracking or shattering of the thin table top can easily ruin the design of the table top. The present invention aims to provide a solution by constructing a tabletop with three layers that allow different designs to be inserted in between the layers of glass. The present invention also provides protection to the designed artwork of the table top. Provided that the protective pane of glass is cracked, the protective pane of glass can simply be removed and replaced.

### BRIEF DESCRIPTION OF THE DRAWINGS

FIG. 1 is a perspective view of the triple pane unit.

FIG. 2 is a top view of the triple pane unit.

FIG. 3 is an exploded view of the triple pane unit.

FIG. 4 is another exploded view of the triple pane unit showing the glass binder unraveled.

FIG. 5 is an exploded view of another embodiment of the present invention where the glass binder is double-sided tapes.

FIG. 6 is a perspective view of the triple pane unit shown in another shape.

### DETAIL DESCRIPTIONS OF THE INVENTION

All illustrations of the drawings are for the purpose of describing selected versions of the present invention and are not intended to limit the scope of the present invention.

The present invention is a method of utilizing existing leaded glass and/or wrought iron designs which is encapsulated in a fully insulated, tempered, triple pane unit. The purpose of the present invention is to protect and further reinforce the structure of a center piece design. The present invention prevents damage to the center piece design by providing an enclosure that can be replaced when damaged, cracked, or chipped.

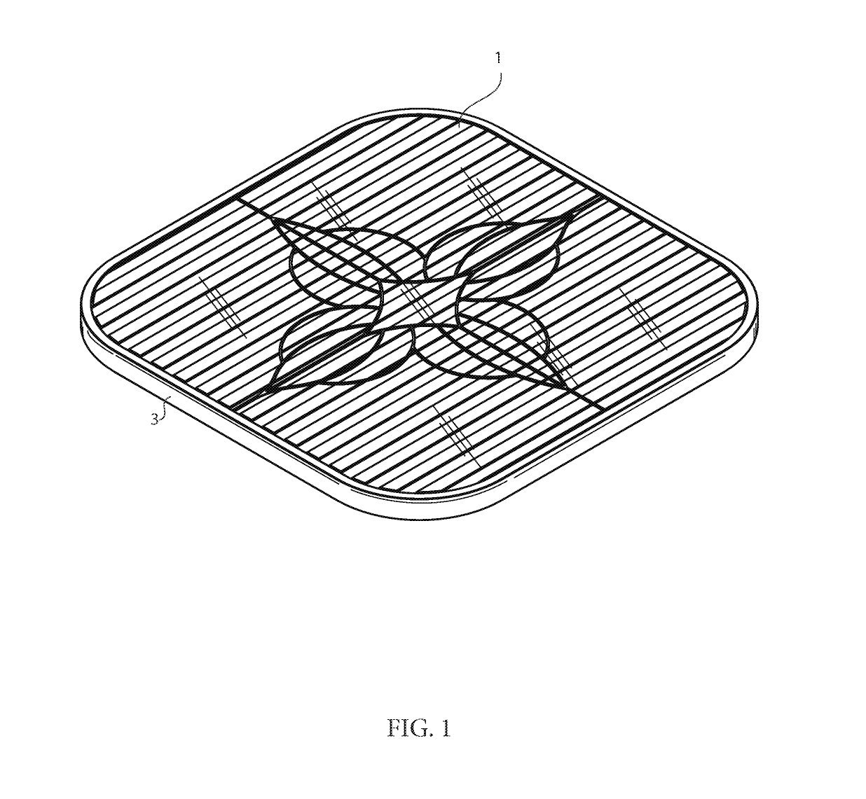

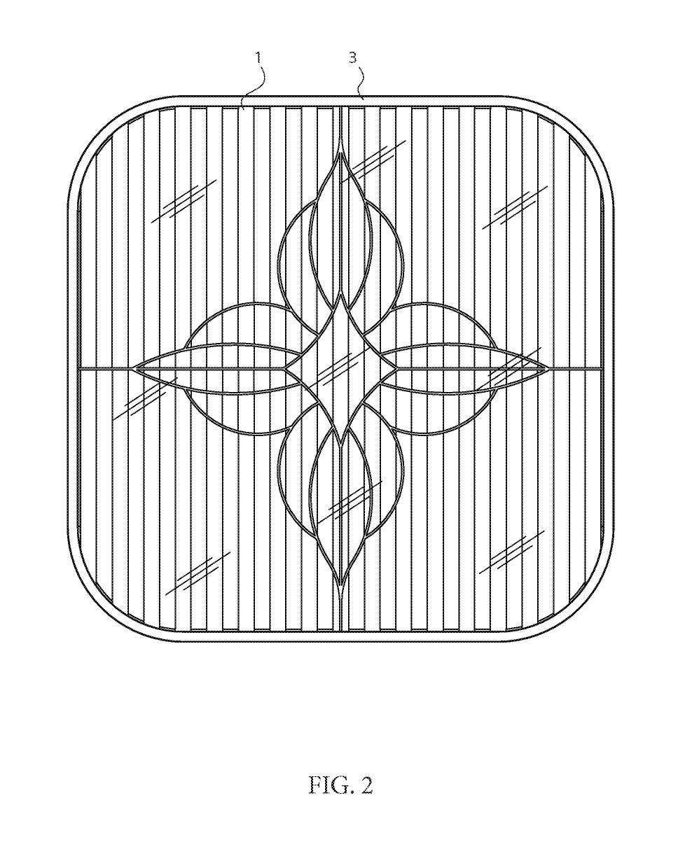

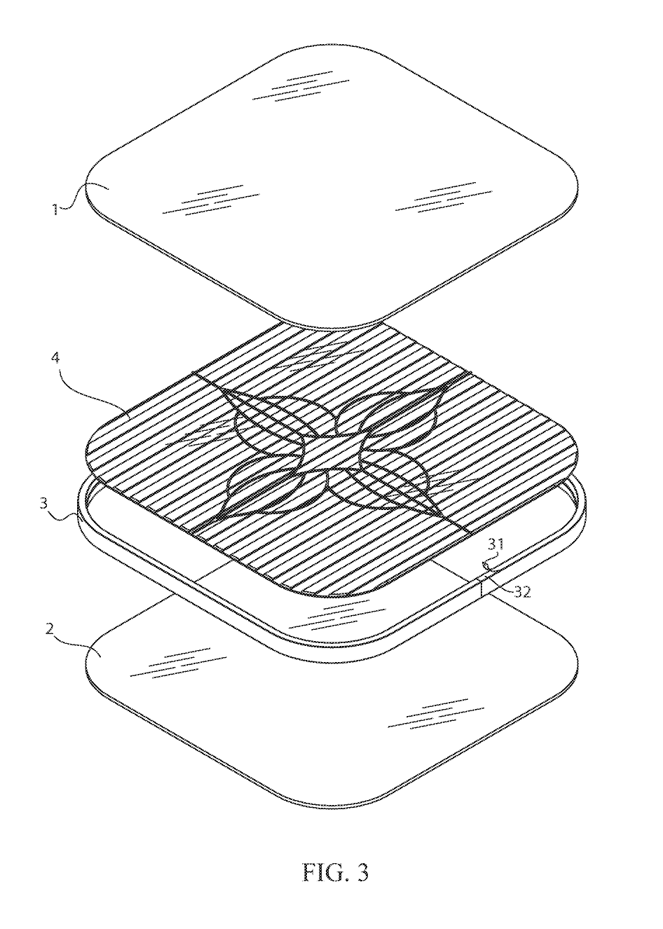

In reference to FIG. 1-5, the present invention utilizes a center piece 4, two panes of glass, and a glass binder 3. The center piece 4 is the design piece that utilizes either leaded glass or wrought iron to provide unique pattern. A traditional patio table top generally only uses the center piece 4 alone as a table top. This can easily lead to damage directly to the center piece 4 and potentially ruin the overall patio table. However, the present invention presents a method that protects the center piece 4. The method involves the encapsulation of the center piece 4 by means of the two panes of glass and the glass binder 3.

The center pieces 4 are existing leaded glass and wrought iron designs that can be encapsulated in a fully insulated, tempered, triple pane unit. Not only can existing leaded glass and wrought iron designs be used to control table tops, but virtually anything can be sealed in using an adhesive binder or any similar securing device to ensure the panels remain secured together.

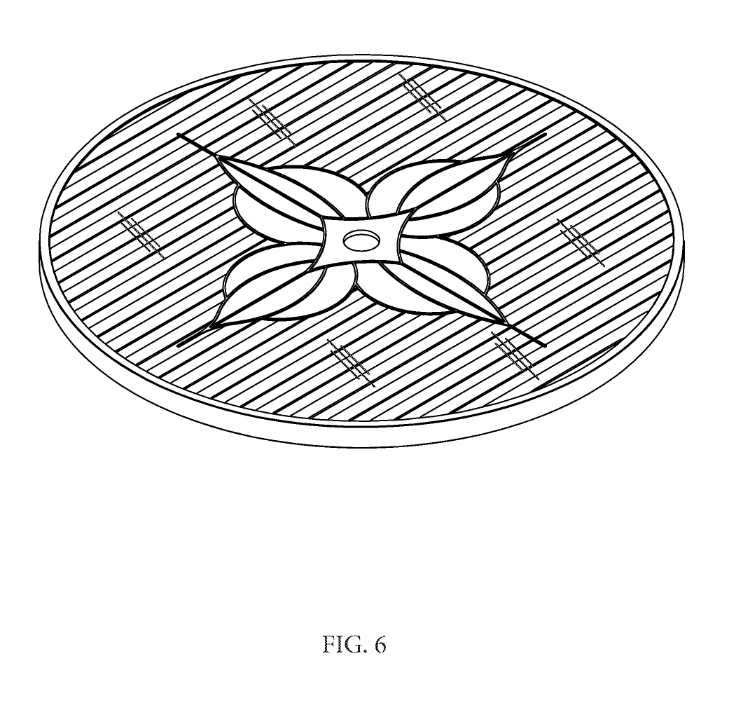

The method in which a triple-paned table top can be constructed to encase a genuinely hand-made leaded glass center piece 4 is initialized by cutting two panes of glass to match the shape of the center piece 4. The center piece 4 can be any design of any shape as shown in FIG. 6. The two panes of glass include a top pane 1 and a bottom pane 2. The glass binder 3 is lined, adhered, and secured onto a perimeter edge of the center piece 4. Once the glass binder 3 is adhered to the perimeter edge of the center piece 4, the top pane 1 is aligned to a top side of the glass binder 3. After peeling a protective backing 31 from the glass binder 3 to reveal an adhesive surface 32, the top pane 1 is pressed and secured to the top side of the glass binder 3. In a similar fashion, the bottom pane 2 is aligned to a bottom side of the glass binder 3. The removal of the plastic backing also revealed the adhesive surface 32 on a bottom side of the glass binder 3. The bottom pane 2 is pressed and secured to the bottom side of the glass binder 3. As a result, the center piece 4 design is completely sealed between the two panes of glass to form a triple pane, fully insulated unit.

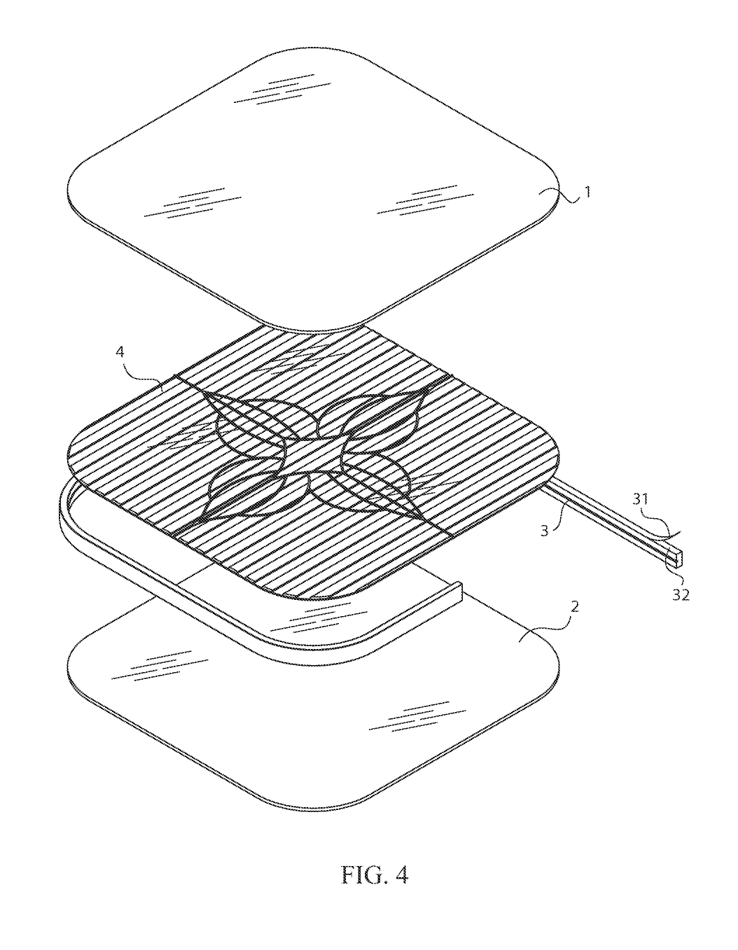

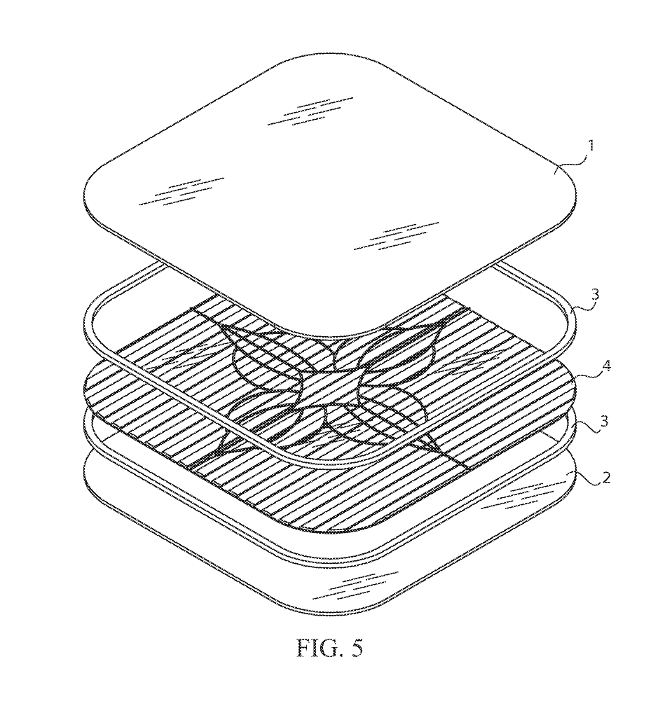

In the preferred embodiment of the present invention, the glass binder 3 is a butyl rubber seal. However, it should be stated that the present invention includes securing the two panes of glass using all possible adhesives including, the glass binder 3 can be any seals selected from the group consisting of rubber spacer, patented TruSeal swiggle butyl with impregnated desiccants, double-sided tapes, double-sided foam tapes, extra-strength glue, or any other type of adhesive binder. Depending of the embodiment of the present invention, the glass binder 3 can be a spacer that wraps around the perimeter edge of the center piece 4 or the glass binder 3 can be the double sided foam tape that is adhered to a top center edge and a bottom center edge of the center piece 4, as shown in FIG. 4 and FIG. 5, respectively. The two panes of glass may be glass of differing thicknesses including, but not limited to, annealed glass, tempered glass, cylinder glass, float glass, prism glass, laminated glass, heat strengthened glass, chemically strengthened glass, low emissivity glass, self cleaning glass, polycarbonate, acrylic, plexi-glass, photochromic glass, or thermochromic glass. However, in the preferred embodiment of the present invention, the two panes of glass used is tempered glass. Additionally, in the preferred embodiment of the present invention, the two panes of glass are ⅛″ thick each. As a result, the overall thickness of the triple pane unit should be at or about ⅝″. The completed unit is air tight and guaranteed to stay air tight under the most severe weather conditions.

In another embodiment of the present invention, the bottom pane 2 can have an incorporated disk that allows the entire apparatus to be attached to a Lazy Susan. This allows the triple pane unit to be placed on top of a larger table as a functional piece that allows objects to be passed around a table while serving as a decorative piece.

Although the invention has been explained in relation to its preferred embodiment, it is to be understood that many other possible modifications and variations can be made without departing from the spirit and scope of the invention as hereinafter claimed.

What is claimed is:

1. A method to construct masterpiece custom triple pane table top comprises, cutting two panes of glass to match the shape a center piece, wherein the two panes of glass include a top pane and a bottom pane;
lining a glass binder about a perimeter edge of the center piece;
adhering the glass binder to the perimeter edge of the center piece;
aligning the top pane to a top side of the glass binder;
pressing and securing the top pane to the top side of the glass binder;
aligning the bottom pane to a bottom side of the glass binder; and
pressing and securing the bottom pane to the bottom side of the glass binder.

2. The method to construct masterpiece custom triple pane table top as claimed in claim 1 comprises,
wherein the glass binder is a seal selected from the group consisting of rubber spacers, butyl with impregnated desiccant, double-sided tapes, and double-sided foam tapes.

3. The method to construct masterpiece custom triple pane table top as claimed in claim 1 comprises,
wherein the two panes of glass can be any glass selected from the group consisting of annealed glass, tempered glass, cylinder glass, float glass, prism glass, laminated glass, heat strengthened glass, chemically strengthened glass, low emissivity glass, self cleaning glass, polycarbonate, acrylic, plexi-glass, photochromic glass, or thermochromic glass.

4. A method to construct masterpiece custom triple pane table top comprises,
cutting two panes of glass to match the shape a center piece, wherein the two panes of glass include a top pane and a bottom pane;
lining a glass binder about a perimeter edge of the center piece;
adhering the glass binder to the perimeter edge of the center piece;
peeling of a protective backing from the glass binder to reveal a adhesive surface;
aligning the top pane to a top side of the glass binder;
pressing and securing the top pane to the top side of the glass binder;
aligning the bottom pane to a bottom side of the glass binder; and
pressing and securing the bottom pane to the bottom side of the glass binder.

5. The method to construct masterpiece custom triple pane table top as claimed in claim 1 comprises,
wherein the glass binder is a seal selected from the group consisting of rubber spacers, butyl with impregnated desiccant, double-sided tapes, and double-sided foam tapes.

6. The method to construct masterpiece custom triple pane table top as claimed in claim 1 comprises,
wherein the two panes of glass can be any glass selected from the group consisting of annealed glass, tempered glass, cylinder glass, float glass, prism glass, laminated glass, heat strengthened glass, chemically strengthened glass, low emissivity glass, self cleaning glass, polycarbonate, acrylic, plexi-glass, photochromic glass, or thermochromic glass.

7. A method to construct masterpiece custom triple pane table top comprises,
cutting two panes of glass to match the shape a center piece, wherein the two panes of glass include a top pane and a bottom pane;
lining a glass binder about a perimeter edge of the center piece;
adhering the glass binder to the perimeter edge of the center piece;
peeling of a protective backing from the glass binder to reveal a adhesive surface;
aligning the top pane to a top side of the glass binder;
pressing and securing the top pane to the top side of the glass binder;
aligning the bottom pane to a bottom side of the glass binder;
pressing and securing the bottom pane to the bottom side of the glass binder;
wherein the glass binder is a seal selected from the group consisting of rubber spacers, butyl with impregnated desiccant, double-sided tapes, and double-sided foam tapes; and
wherein the two panes of glass can be any glass selected from the group consisting of annealed glass, tempered glass, cylinder glass, float glass, prism glass, laminated glass, heat strengthened glass, chemically strengthened glass, low emissivity glass, self cleaning glass, polycarbonate, acrylic, plexi-glass, photochromic glass, or thermochromic glass.
